(19) United States
(12) Patent Application Publication
(10) Pub. No.: US 2017/0198474 A1
(43) Pub. Date: Jul. 13, 2017

(54) Electronically Controlled Mechanically Adjustable Acoustic Panel System

(71) Applicants: Matthew Graves, Fort Wayne, IN (US); Richard Kinney, JR., Fort Wayne, IN (US)

(72) Inventors: Matthew Graves, Fort Wayne, IN (US); Richard Kinney, JR., Fort Wayne, IN (US)

(21) Appl. No.: 14/990,517

(22) Filed: Jan. 7, 2016

(51) Int. Cl. E04B 1/99; G05B 19/414; G05B 19/042; G05B 19/402; E04B 1/343; E04H 3/30

(52) U.S. Cl. CPC E04B 1/994; E04B 1/343; E04H 3/30; G05B 19/0426; G05B 19/402; G05B 19/4145; G05B 2219/36507

(57) ABSTRACT

An acoustic modulation system for a physical space, said system comprising: at least one acoustic panel, each of said at least one acoustic panel movably attached to a frame; a motor for moving said at least one panel relative to said frame, said motor mechanically connected to each of said at least one panels; a programmable controller, said controller operatively connected to said motor, said controller adapted to selectively engage said motor to move at least one panel of said at least one panel.

### BACKGROUND

1. Field of the Invention

The present invention relates to acoustic panels such as diffusers and absorbers and, more particularly, to physical spaces having computer controlled mechanically movable acoustic panels.

2. Description of the Prior Art

It is well know that the acoustic properties of even a well designed physical space are static. Indeed, generally a physical space such as a sound studio is, at best, designed to accommodate a variety of possible sound recordings, including different musical styles and band sizes as well as other types of audio recordings.

Acoustical engineers digitally alter any sound recordings using digital audio processors to provide the best solution to a hypothetical sound profile. This profile is an approximation given the stated use of the venue. As with all approximations or estimates, the results are not unique to each performance that may take place at a venue and may provide suboptimal results based upon the sound profile of the actual event or performance that takes place in the venue. Sound engineers often use “equalizers” to digitally process audio recordings. Software within the equalizer uses feedback from the sound profile of the room in an algorithm that finds the optimal volume and sound characteristics for the sound profile present in the room.

Equalizers are an essential part of any sound system. They have many applications for various users. An equalizer is a filter that allows a person to control the tone (frequency response), of a sound system. There are two major types, graphic equalizers, and parametric equalizers.

The graphic equalizer allows a user to graphically perceive how the controls are set simply by looking at it. Graphic equalizers are most commonly seen on high-end sound systems for large indoor spaces like halls, churches, etc. However, for much finer control a parametric equalizer might be considered.

Equalizers are built to control the loss and gain of frequencies within a sound system. This allows a sound system to maximize volume while eliminating feedback. The system may accommodate adjustments that account for the ambient sound in the room, but do help compensate for the “acoustics” in the room.

Equalizers are frequently used in public address systems to sharpen the sound and reduce echoes. Stadiums, sports arenas and other venues will want a good sound system with a good equalizer. Churches, with their unusually angled rooms and ceilings will especially benefit from having an equalizer in the sound system. As churches often have multiple microphones and speakers, a stereo equalizer is a must. Schools will want an equalizer to maximize sound output in various venues from auditoriums to gyms. Basketball and volleyball events are enhanced by quality audio equipment allowing for crisp, clear announcements. Bands, and other live traveling shows will perhaps find the equalizer most useful, as it is nearly impossible to construct a good sound system for every venue without adjusting for frequencies that will create feedback.

Originally, analog equalizers worked by passing an AC (alternating current) signal through capacitors and inductors. The phase of the signal was shifted as it passed through. This shifted signal was then recombined with the original signal for a cancelling or partially cancelling effect (frequencies can also be enhanced). This could be done for specific frequencies so that different frequencies could be adjusted to certain levels simultaneously.

Today's modem digital equalizers mimic the behavior of analog equalizers. They do this using taps on a digital delay line. This is really a series of memory locations that the signal (or at least a number representing the signal) is passed through. It goes first to location 0, then to location 1 and then 2 and so on until it reaches the output phase. This setup is called a shift register and the effect is the same as if the signal was passed through a capacitor and an inductor.

One can vary the signal by changing how many cells are in the shift register or by choosing different registers as the output. The signal is recombined with the original signal with the expected result.

The great advantage of a graphic equalizer over other equalizers is that it is easy to visualize and adjust the controls. Most people have seen the typical sliding controls. The drawbacks of the graphic equalizer are that it has fixed frequencies and Q, which limits the user's ability to be precise.

Graphic equalizers generally have a Q designated as a 1, 2 or 3. These numbers basically describe how much of an octave each frequency control covers. The designation 1 covers one octave, a two means that each control covers ½ octave, and a 3 covers ⅓ of an octave. This means the higher the Q, the smaller the range covered, but the more precise each control can be.

The little slide buttons are called potentiometers. They are placed side-by-side on the graphic display. Normally the slides will form a smooth wave pattern. This is because the noise being cancelled or enhanced generally spans more than one frequency in different strengths.

Computers can function as a graphic equalizer when processing music and sound files for its speakers. The interface on the computer normally looks very much like a graphic equalizer's controls on a separate unit.

A parametric equalizer allows the user to change the frequency and Q. However, this benefit is offset by the fact that this very ability complicates the inexperienced user's efficacious use of the system. Adjustments can be so complex that needed changes might be difficult to determine.

A parametric equalizer uses knobs for its control functions, which makes it more difficult to visualize the set-up of the equalizer. Even so, it admirably performs the main functions of an equalizer which is to control the loss and gain in a frequency within a sound system.

Parametric equalizers usually have 3 to 6 bands. Some have overlapping frequency ranges. Others have broadband control which allow them to be used over the complete frequency range. Most parametric equalizers have a switchable range switch that allows operation in a ×1 or ×10 mode, allowing the frequency to be equalized on an even finer scale.

Digital audio processing and manipulation is necessarily limited by the physical properties of the venue. Digital audio processing methods are also limited by the number of speakers surrounding the event and the types of adjustments that may be possible given the equipment provided. Another limitation of such prior art systems and methods of achieving ideal sound recordings is that the desired amount of digital processing of the sound recorded at a particular venue varies. Moreover, a large public address system is not always avoidable at a live music concert hall, recording studio or small venue. Thus, prior art devices, systems, and methods that have been developed for altering or accommodating the acoustic limitations of physical space for recording sound as shown below.

U.S. Pat. No. 5,498,127 discloses an active liner for attenuating noise having a rigid backplate supporting a piezoelectric panel. A pressure transducer is disposed in the panel for sensing acoustic pressure of noise being propagated against a face surface of the panel. A controller includes a predetermined schedule of acoustic impedance for controlling a displacement driver joined to the panel to effect a displacement velocity of the panel face surface for obtaining a predetermined acoustic impedance at the sensed acoustic pressure for attenuating noise.

U.S. Pat. No. 5,623,130 discloses a system utilizing a series of sound absorbant baffles which are spaced along intersecting wall and ceiling surfaces of a room or alternatively entirely on a wall surface to absorb sound waves moving in an oblique manner to the surfaces. The baffles are of a low density material with faces projecting from the wall and ceiling surfaces. Sealant applied to baffle edges ensures gap free securement to wall and ceiling surfaces. The baffles do not significantly interfere with sound moving perpendicular to the wall and ceiling surfaces to preserve desired acoustical characteristics of a room. Mounting brckets including clips may be provided for attaching the baffles to room surfaces in a removable manner.

U.S. Pat. No. 5,896,710 discloses an acoustic panel system is provided for partially acoustically isolating a portion of a space in, for example, a recording studio. The acoustic panel system is modular in design and includes a plurality of different sized acoustic panels which can be assembled together in various configurations to form complete or partial acoustically isolated areas within a space. The acoustic panel system includes wall mount members, wall panels, floor panels, ceiling panels, transparent viewing panels and door panels. The wall mount members are basically partial members either permanently or removably interconnected with the walls of a space. The wall panels can be interconnected with the wall mount members. The wall panels may include casters for facilitating the movement thereof, and may also include feet for supporting the panels on uneven flooring. The wall panels further include recesses along the upper edges thereof for cooperating with the casters and/or clips interconnected with the casters, on lower edges of the panels to allow for such panels to be stacked. Additionally, such wall panels can be connected together along the sides thereof to form partial or complete enclosures as desired.

U.S. Pat. No. 6,006,476 discloses a system for controlling acoustics and emissivity in an arena having a ceiling. The system includes a pair of rollers mounted adjacent the ceiling and spaced apart over at least a portion thereof. A plurality of acoustics and emissivity controlling panels connected together to form a continuous sheet are mounted between the rollers for movement across the ceiling when the rollers are rotated. The panels include one having a high emissivity surface of at least 90%, one having a low emissivity surface of 7% or less and one having an acoustical surface with sound absorbing characteristics.

U.S. Pat. No. 6,616,804 discloses a fiberboard acoustical panel has a fiberboard which includes a fibrous filler and a base binder, and a nodulated overlay disposed on the fiberboard, wherein the overlay includes nodulated wool and an overlay binder and has a substantially smooth surface. In one embodiment, the fibrous filler is mineral wool and the base binder is granular starch.

U.S. Pat. No. 7,210,897 discloses a space having a sound absorption panel and active sound absorption control system between inner and outer walls of a nacelle forming an engine intake/exhaust duct. The panel section defines a sound absorption space by means of surface plate made of a perforated plate and wire mesh materials plate, panel construction side plate and back sheet plate having porous sound absorption material stuck thereon; and a movement-controlled reflective plate, that is capable of movement/rotation control with respect to said perforated plate, is provided within this sound absorption space. Movement of the reflective plate is controlled utilizing the adaptive feed forward control method by means of the output from an active sound absorption control system section.

U.S. Pat. No. 7,213,680 discloses an acoustical wall covering assembly with pleats formed and attached to a trim member for covering a wall of a movie theatre, in which a panel of an acoustical wall covering attaches to a pleating member having groups of scores for folding to define the pleats. A method of forming and securing an acoustical pleated panel to cover a wall is also disclosed.

U.S. Pat. No. 8,714,303 discloses an acoustic tuning panel having a plurality of boards and a plurality of resonance tubes with a plurality of openings. The openings are formed at different positions on the side faces of the resonance tubes. One resonance tube may be interposed in and supported by a pair of boards, or one board may be interposed in and supported by a pair of resonance tubes. The resonance tubes are mutually movable in the axial direction so as to independently adjust the opening area of the opening of the resonance tube thereby adjusting the sound-absorbing effect and sound-scattering effect in an acoustic space.

U.S. Pat. No. 9,145,675 discloses a tunable acoustic panel that functions as an acoustic diffuser and absorber. The acoustic properties of the tunable acoustic panel can be modified by moving a handle. The tunable acoustic panel is wall-mountable for use as an acoustical room treatment to selectively vary the acoustical response of a room or performance space.

Unfortunately, the properties of the room itself cannot be changed without physically removing and replacing existing acoustic panels with a new panels possessing different properties than the original ones. Thus, none of the prior art systems or methods fully address the need for a single performance space with optimal acoustics for a variety of uses. What is needed in the art, therefore, is a performance space comprising means for selectively altering the physical space to optimize its acoustical properties for specific sound recordings.

### SUMMARY

The mechanically adjustable acoustical panel system or the present invention allows a user to optimize a physical space for multiple types of sound profiles for events and performances. The system of the present invention comprises a plurality of movable, modular panels and an electronic control device for controlling the motion of the panels. Each modular panel may comprise wood, metal or composite frame that varies in size and can be custom manufactured to fit most surfaces. Each mechanically adjustable acoustical panel can physically move to alter the acoustical properties of the room in which it is installed.

The panels of the present system can be installed throughout a room on any vertical or horizontal surface. The system may comprise multiple baffles with multiple surfaces where each surface has different acoustical properties thus providing a user with significant ability to optimize the physical acoustical properties of a given room or venue.

Thus, the present invention allows a user to tune, adjust and optimize the acoustic performance of a given room or venue by physically changing the acoustical properties of the space. Prior art systems and methods for room acoustics include only stationary /fixed panels or digital audio processing.

The system of the present invention further comprises software control means for moving the mechanically adjustable acoustical panels. The present system may, for example, use input from microphones to inform the system controller to adjust the location or orientation of the wall mounted acoustical panels.

In one exemplary embodiment, the system of the present invention comprises an acoustic modulation system for a physical space, said system comprising: at least one acoustic panel, each of said at least one acoustic panel movably attached to a frame; a motor for moving said at least one panel relative to said frame, said motor mechanically connected to each of said at least one panels; a programmable controller, said controller operatively connected to said motor, said controller adapted to selectively engage said motor to move at least one panel of said at least one panel.

In another exemplary embodiment, the system of the present invention comprises a method of modifying the acoustic characteristics of a predetermined physical space, said method comprising the steps of: providing a plurality of selectively movable acoustic panels; providing a motor, said motor operatively connected to said panels; providing a controller, said controller functionally connected to said motor; providing a plurality of sensors, said sensors selected from the group consisting of microphones, hall effect sensors, and thermometers, said sensors communicatively connected to said controller; programing said controller to move at least one panel of said plurality of movable panels according to a predetermined algorithm and data inputted to said controller from said sensors.

In another exemplary embodiment, the present invention comprises a method of modifying the acoustic characteristics of a recording space, said method comprising the steps of: providing a plurality of selectively movable acoustic panels; providing a motor, said motor operatively connected to said panels; providing a controller, said controller functionally connected to said motor; providing a plurality of sound profile data, said sound profile data matching the acoustic properties of a known physical space; providing a plurality of microphones in said recording space; inputting sound profile data from said microphones into a software program; using said program to compare the sound profile data for the recording space to the sound profile data of the known physical space; programing said controller to move at least one panel of said plurality of movable panels according to a predetermined algorithm to adapt said recording space to match the acoustic properties of said known physical space.

### BRIEF DESCRIPTION OF THE DRAWINGS

The present invention will be understood more fully from the detailed description given hereinafter and from the accompanying drawings of the preferred embodiment of the present invention, which, however, should not be taken to limit'the invention, but are for explanation and understanding only.

In the drawings:

FIG. 1 shows a side view of an exemplary embodiment of an apparatus according to the present invention.

FIG. 2 shows a top view of the apparatus in FIG. 1.

FIG. 3 a side view of the apparatus in FIG. 1 with the panels partially turned.

FIG. 4 a top view of the apparatus of FIG. 3.

FIG. 5 a side view of the apparatus of FIG. 1 with the panels turned 90°.

FIG. 6 a top view of the apparatus of FIG. 5.

FIG. 7 shows a side view of an alternative exemplary embodiment of an apparatus according to the present invention.

FIG. 8 shows a top view of the apparatus of FIG. 7.

FIG. 9 shows a side view of the apparatus of FIG. 7 with the panels partly turned.

FIG. 10 shows a top view of the apparatus of FIG. 9.

FIG. 11 shows the apparatus of FIG. 7 with the panels turned 90°.

FIG. 12 shows a top view of the apparatus of FIG. 11.

FIG. 13 shows a side view of an alternative exemplary embodiment of an apparatus in accordance with the present invention.

FIG. 14 shows a top view of the apparatus of FIG. 13.

FIG. 15 shows the apparatus of FIG. 14 with the panels partly turned.

FIG. 16 shows a top view of the apparatus of FIG. 15.

FIG. 17 shows a side view of the apparatus of FIG. 13 with the panels turned 90°.

FIG. 18 shows a top view of the apparatus of FIG. 17.

FIG. 19 shows a side view of an alternative exemplary embodiment of an apparatus according to the present invention.

FIG. 20 shows a top view of the apparatus of FIG. 19.

FIG. 21 shows a side view of the apparatus of FIG. 19 with the panels party turned.

FIG. 22 shows a top view of the apparatus of FIG. 21.

FIG. 23 shows a side view of the apparatus of FIG. 19 with the panels turned 90°.

FIG. 24 shows a top view of the apparatus of FIG. 23.

FIG. 25 shows a side view of an exemplary embodiment of the present invention with three sided baffles.

FIG. 26 shows a top view of the apparatus of the FIG. 25.

FIG. 27 shows a side view of the apparatus of FIG. 25 with the baffles partly turned.

FIG. 28 shows a top view of the apparatus of FIG. 27.

FIG. 29 shows a side view of the apparatus of FIG. 25 with the baffles turned 90°.

FIG. 30 shows a top view of the apparatus of FIG. 29.

FIG. 31 shows a side view of an alternative embodiment of the present invention with three sided baffles.

FIG. 32 shows a top view of the apparatus of FIG. 31.

FIG. 33 shows a side view of the apparatus of FIG. 31 with the baffles partly turned.

FIG. 34 shows a top view of the apparatus of FIG. 33.

FIG. 35 shows a side view of the apparatus of FIG. 31 with the baffles turned 90°.

FIG. 36 shows a top view of the apparatus of FIG. 35.

FIG. 37 shows a side view of an alternative embodiment of the present invention with three sided baffles.

FIG. 38 shows a top view of the apparatus of FIG. 37.

FIG. 39 shows a side view of the apparatus of FIG. 37 with the baffles partly turned.

FIG. 40 shows a top view of the apparatus of FIG. 39.

FIG. 41 shows a side view of the apparatus of FIG. 37 with the baffles turned 90°.

FIG. 42 shows a top view of the apparatus of FIG. 41.

FIG. 43 shows a side view of an alternative embodiment of the present invention with three sided baffles.

FIG. 44 shows a top view of the apparatus of FIG. 43.

FIG. 45 shows a side view of the apparatus of FIG. 43 with the baffles partly turned.

FIG. 46 shows a top view of the apparatus of FIG. 45.

FIG. 47 shows a side view of the apparatus of FIG. 43 with the baffles turned 90°.

FIG. 48 shows a top view of the apparatus of FIG. 47.

FIG. 49 shows a flow chart of a control method for use with the present invention.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, system 1000 of the present invention generally comprises a frame 100 (shown in FIG. 1 only), a plurality of baffles 200 movably mounted to frame 100, a drive apparatus 300 functionally connected to baffles 200, and a control apparatus 400 functionally connected to the drive apparatus.

Referring again to FIG. 1, system 1000 of the present invention can be attached to any flat surface of a physical space, such as a room or sound studio. Frame 100 supports at least one movably mounted vertical or horizontal baffles 200. Each baffle 200 preferably comprises a multiple sides or panels 210. In a preferred embodiment, each panel 210 is comprises a unique material or is covered with a unique facing material. In either instance, each panel 210 of each baffle 200 may comprise a different acoustical absorption coefficient ranging from very acoustically absorbent to highly acoustically reflective. The facing materials for each panel 210 can be customized or modified to provide the widest ranging benefit to the end user. The number of baffles 200 or panels 210 in each baffle can be adjusted based on the dimension of the physical space or the desired acoustic properties for the space in which system 1000 is installed. Those of ordinary skill in the art, however, will appreciate that each baffle 200 may comprise one side panel 210 or multiple panels 210.

Moreover, baffles 200 and corresponding panels 210 can be manufactured and sold as a kit containing various sizes or material specifications for panels 210. The panels could also be manufactured and delivered as a custom project solution. In a large theater, for example, panels 210 can be custom manufactured in sizes and quantities that meet the specific needs and space of a unique venue.

Acoustical panels 210 can be manufactured from many different materials providing the end user with the opportunity to customize the appearance of the finished product. Different materials, stains, paints and fabrics can be applied to create a custom appearance that may highlight the mechanics of panel 210 or may hide the mechanics of the panel 210 completely.

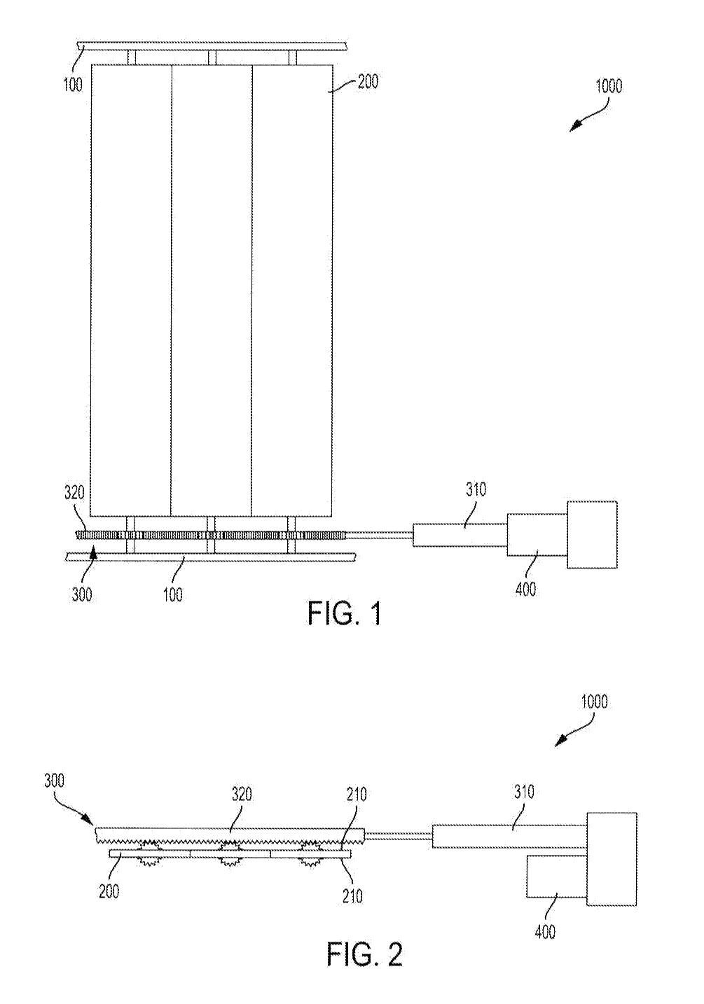

As illustrated in FIG. 1, the preferred embodiment of system 1000 comprises a plurality of baffles 200 movable mounted on frame 100. In one exemplary embodiment, shown in FIG. 2, baffles 200 are rotatably mounted on frame 100.

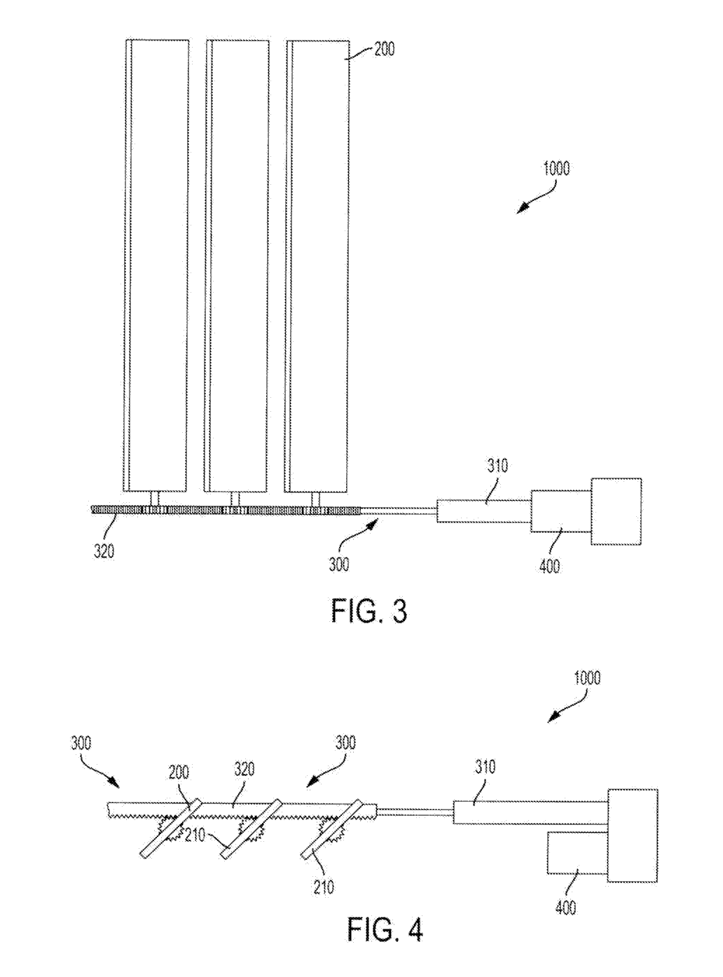

Referring now to FIG. 2 and FIG. 3, in one exemplary embodiment of system 1000 of the present invention, each baffle 200 may function independently or in a group. The kit of panels will share a power supply but still be switched independently. This independent switching will allow the end user to optimize the performance of the venue but share in cost savings by sharing a power supply.

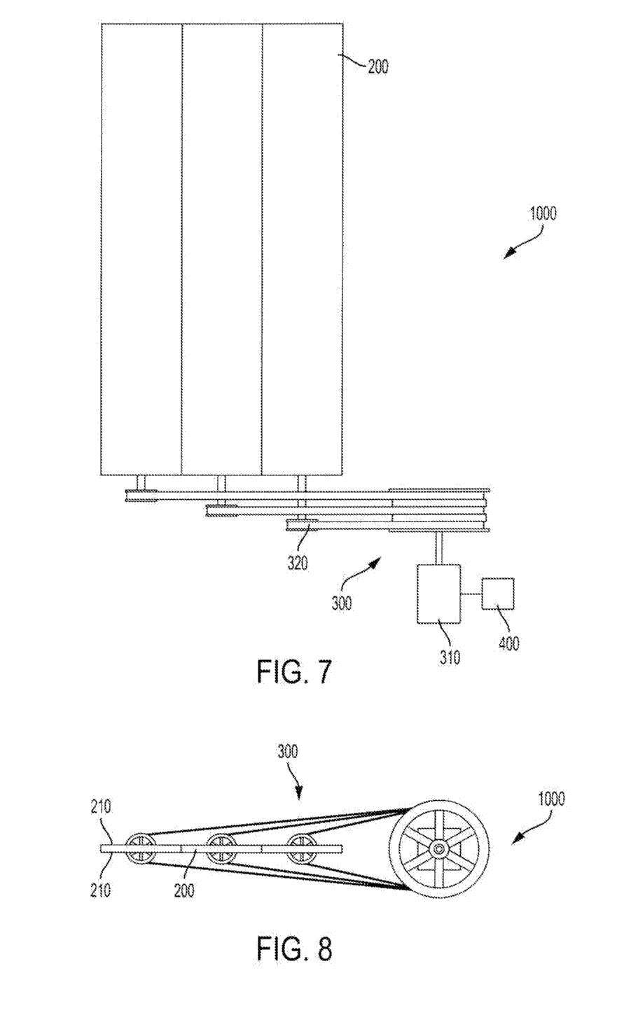

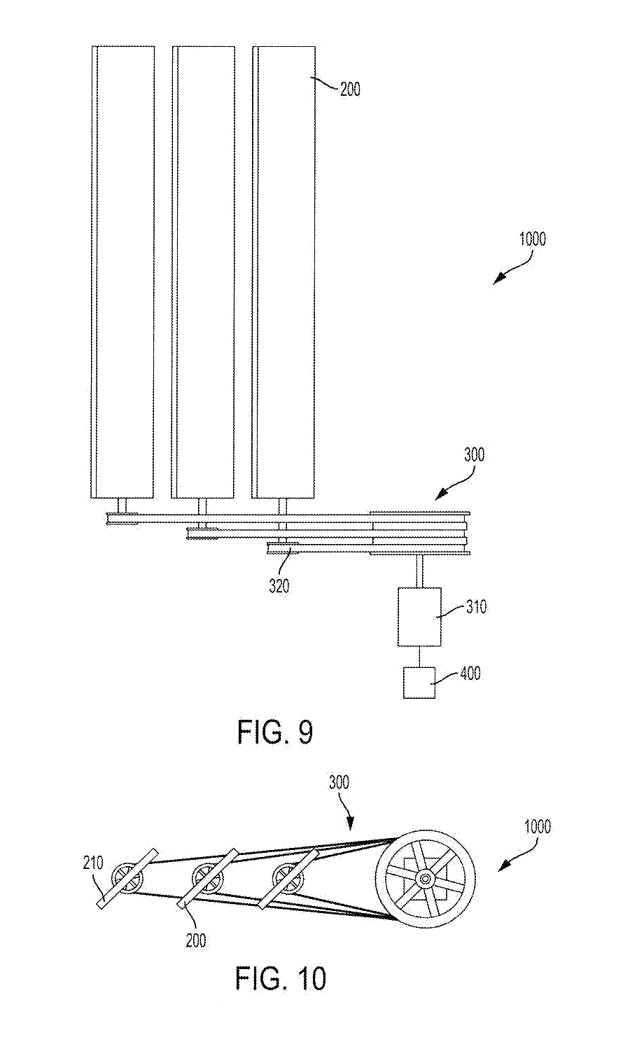

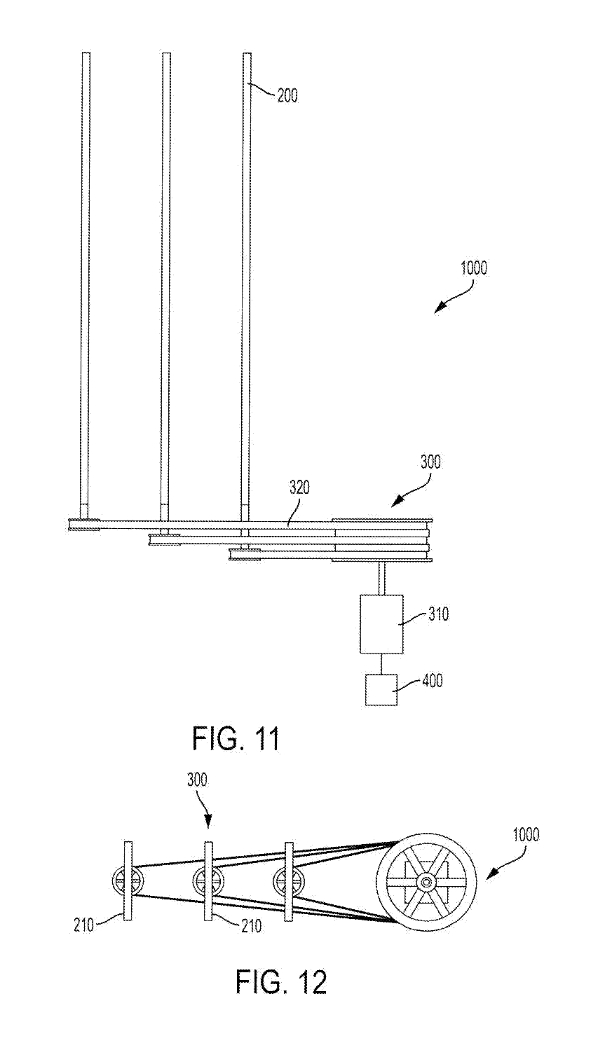

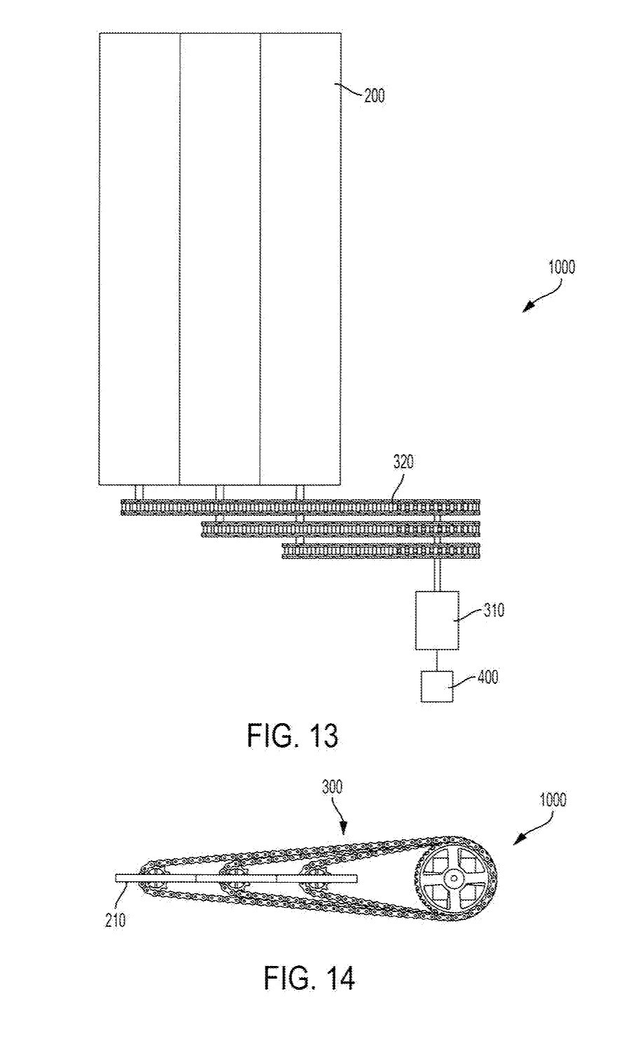

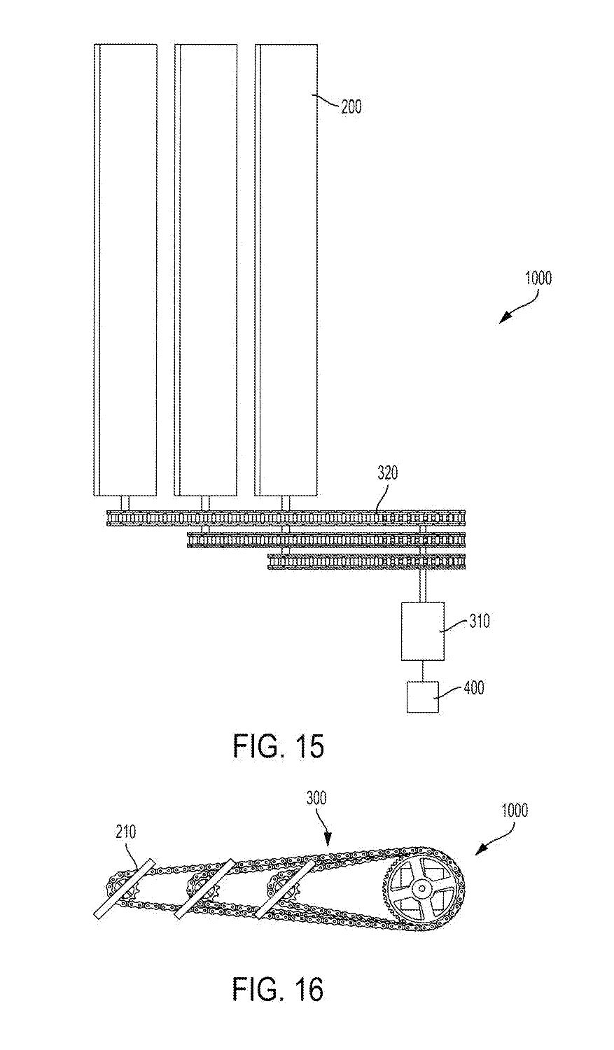

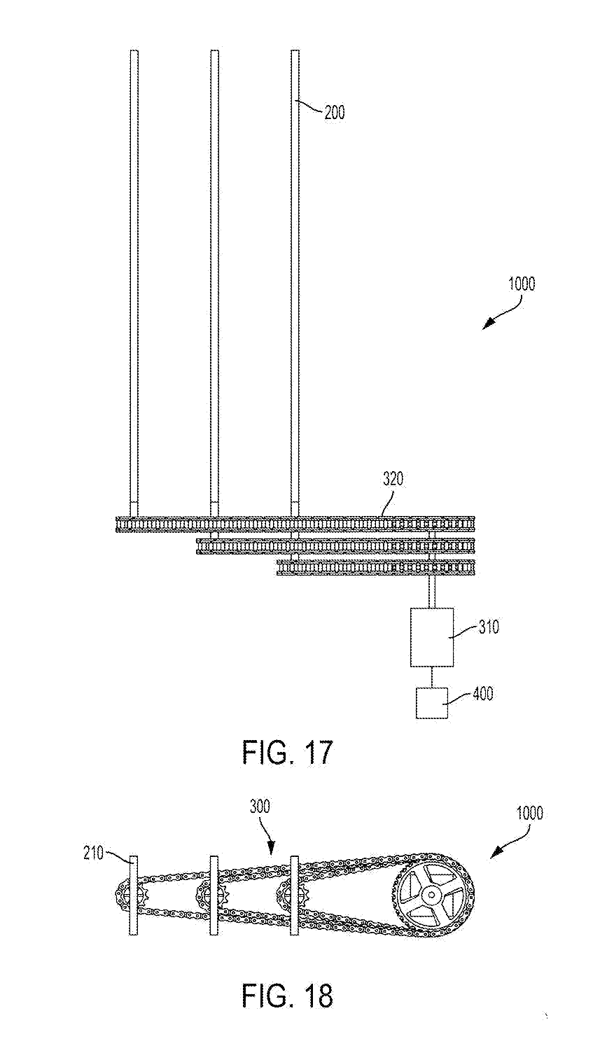

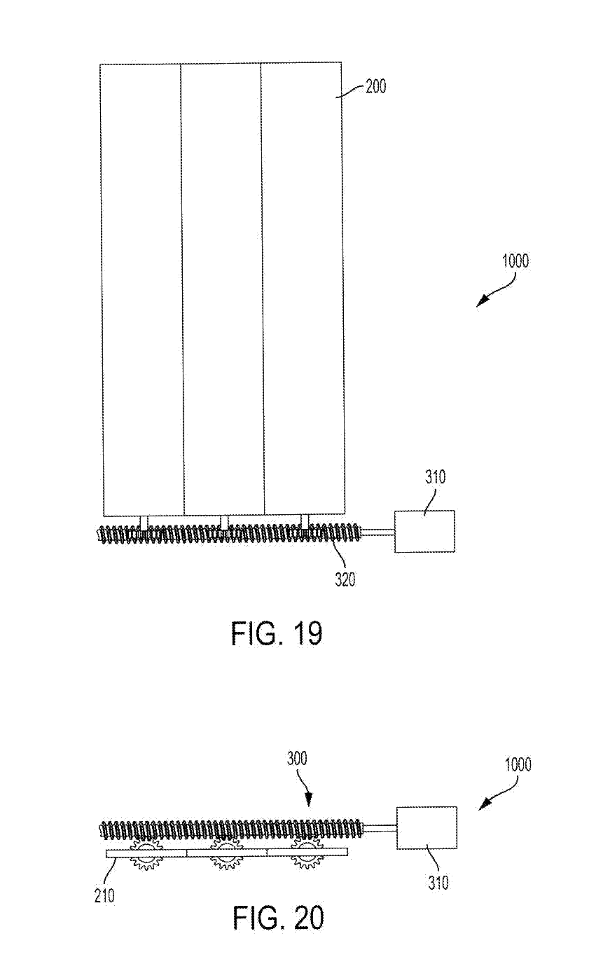

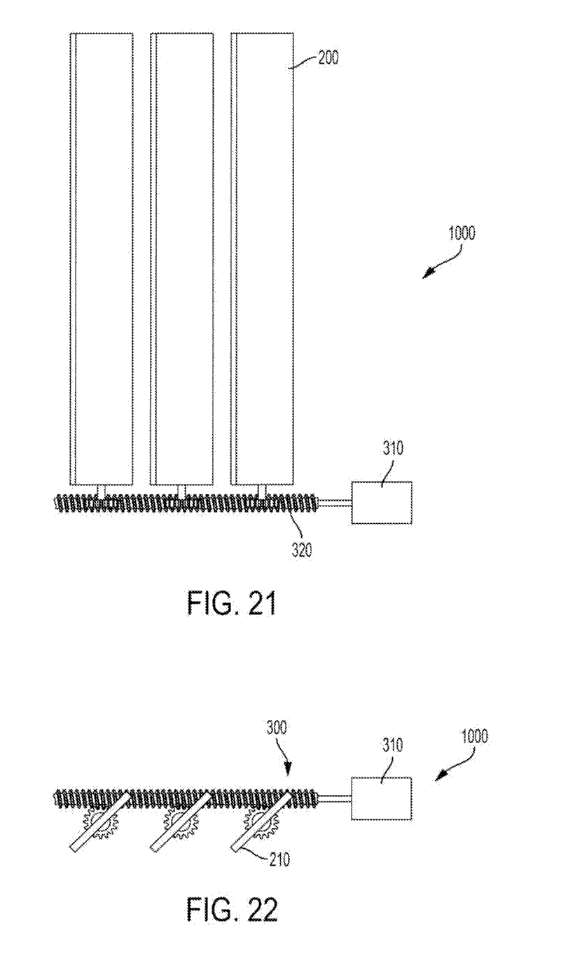

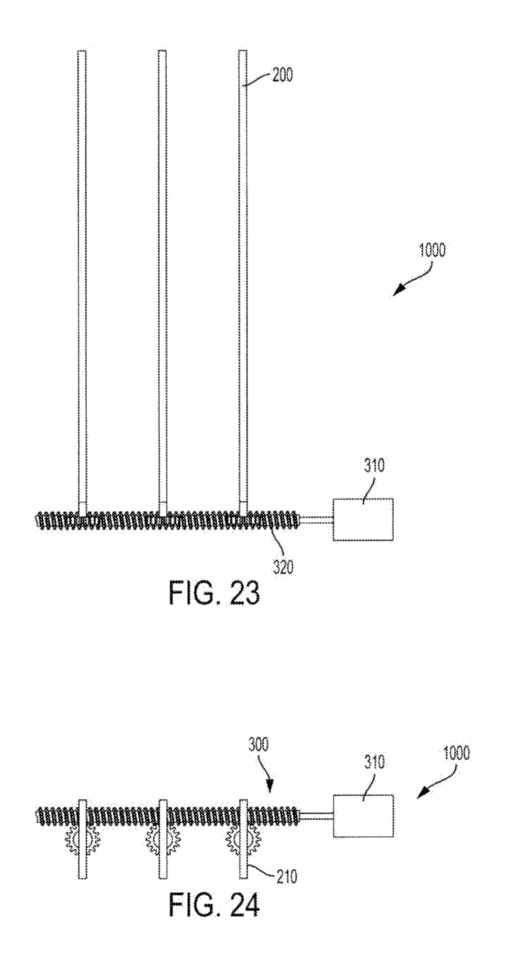

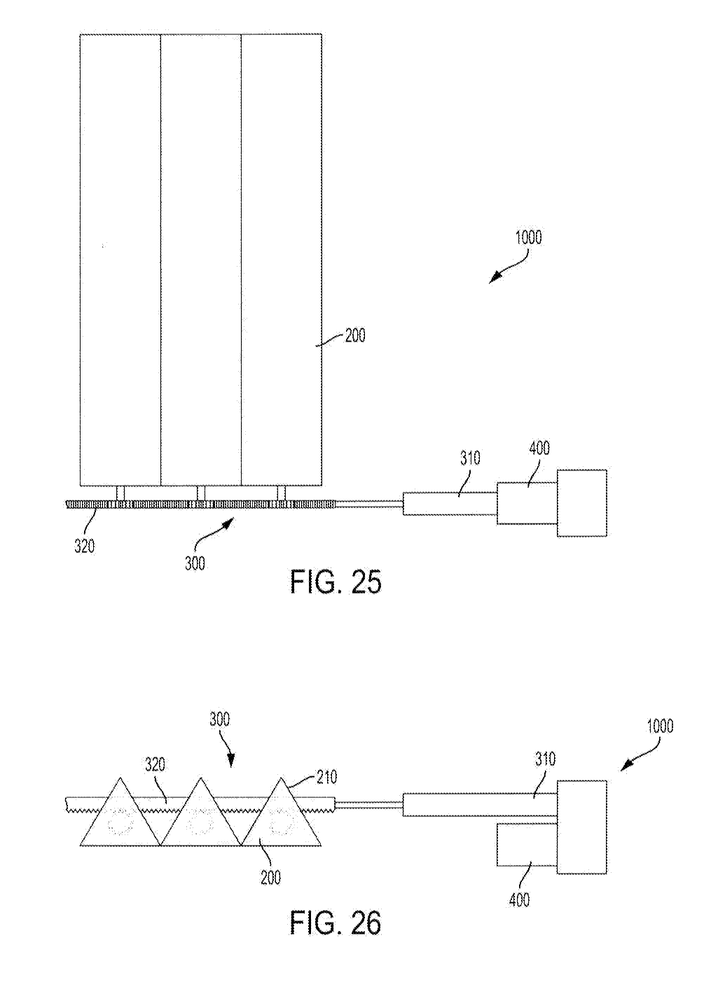

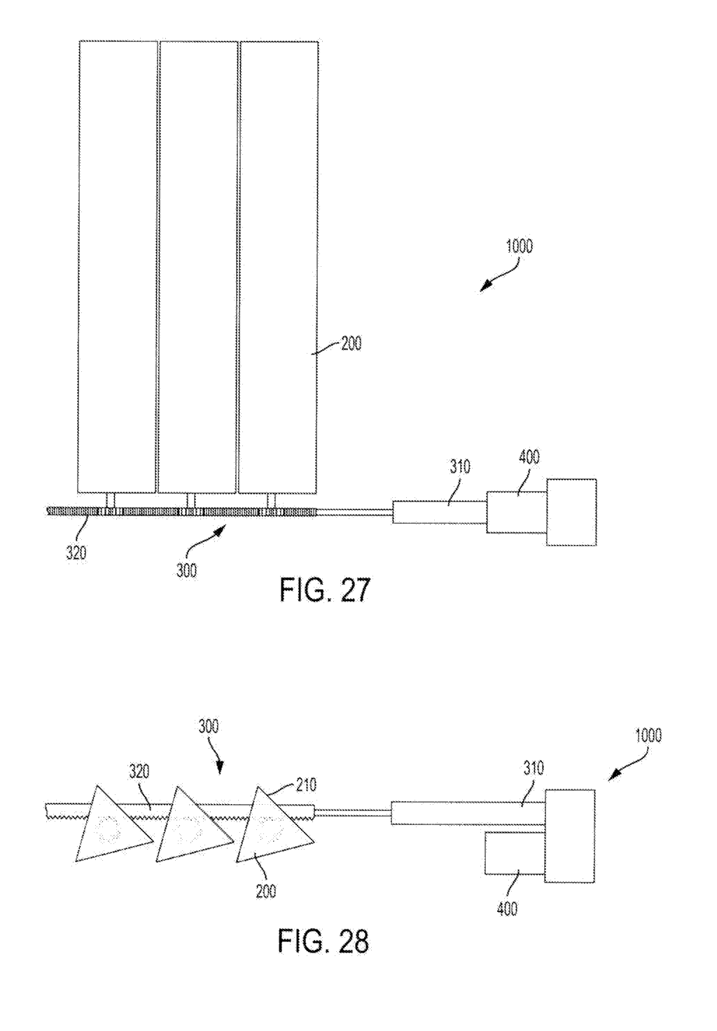

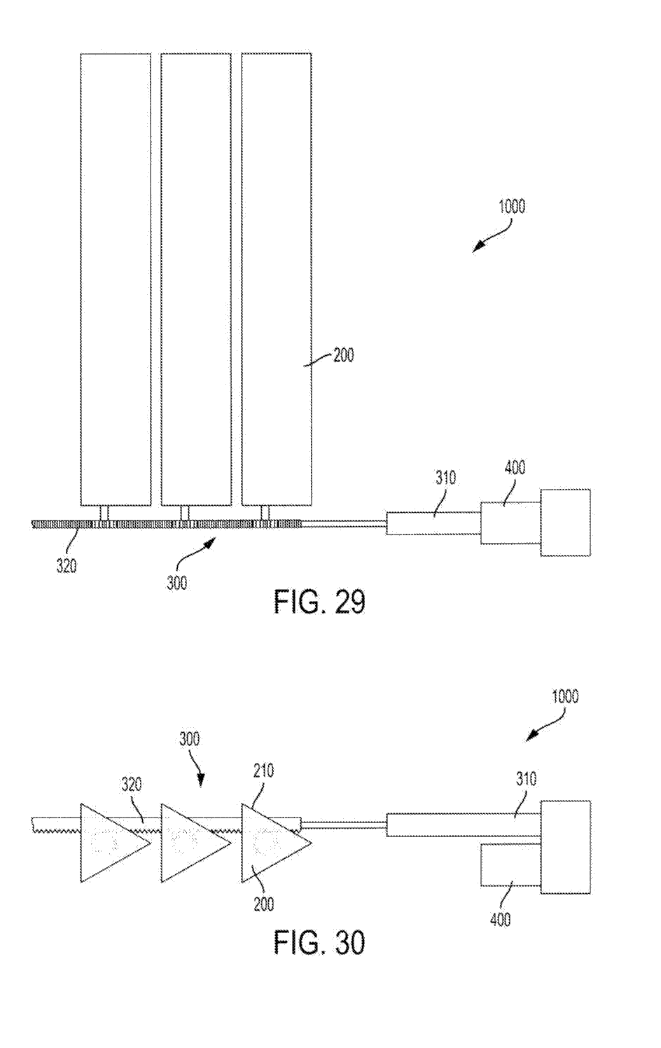

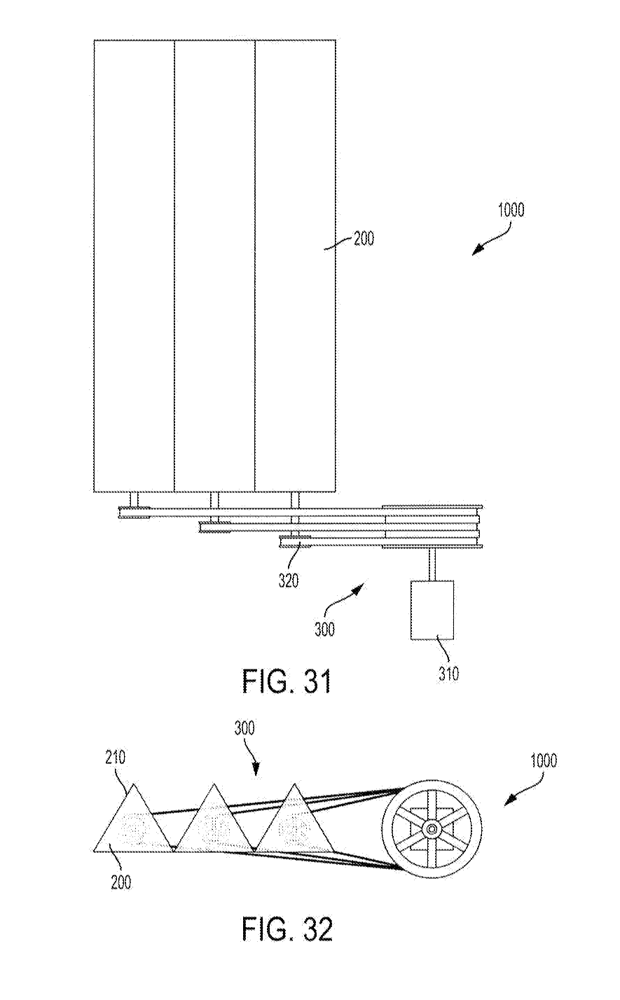

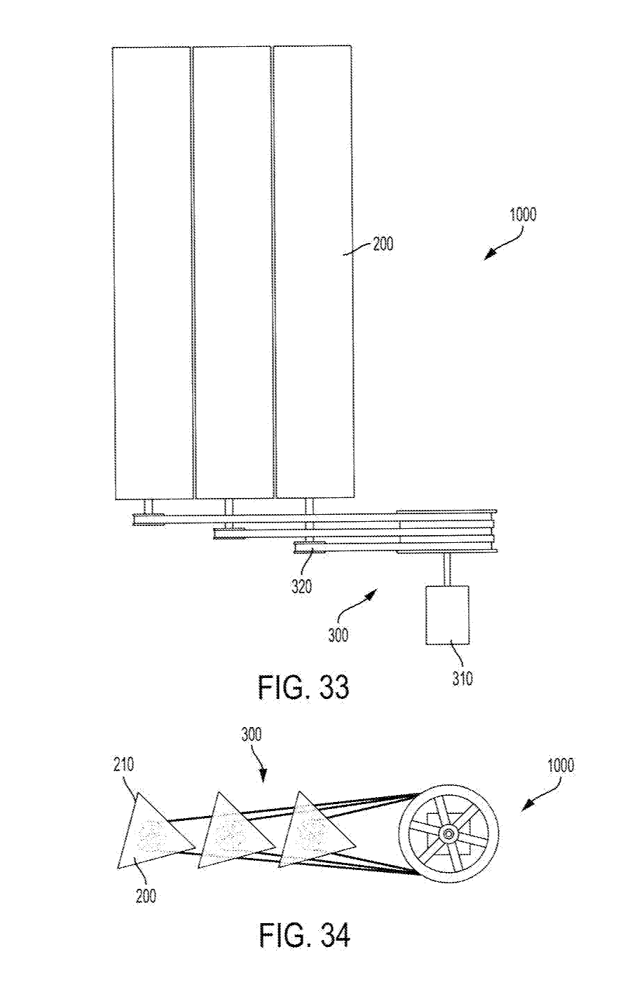

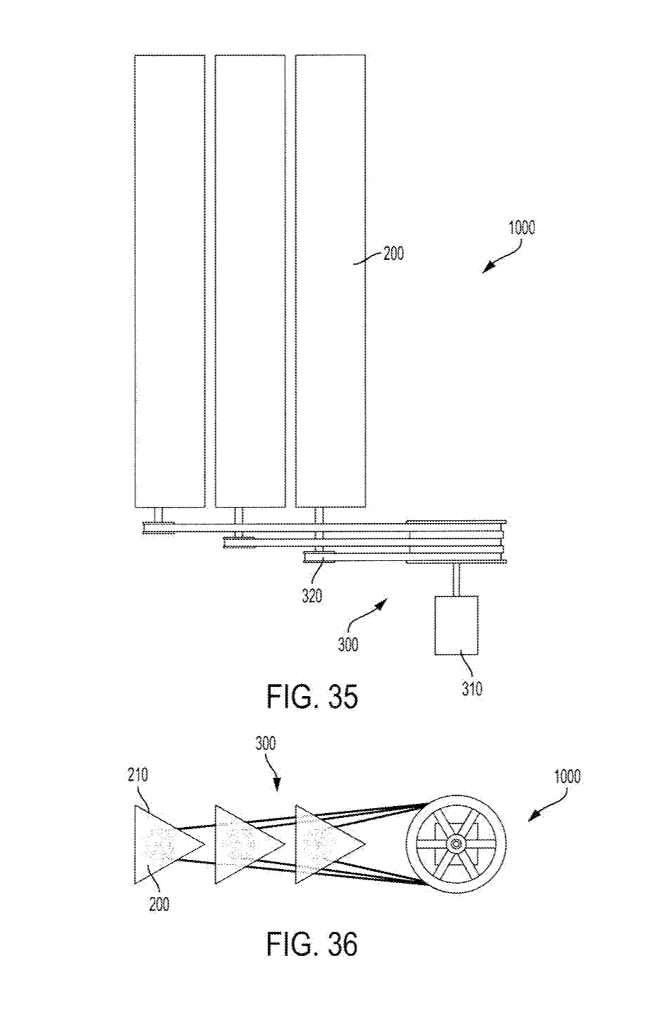

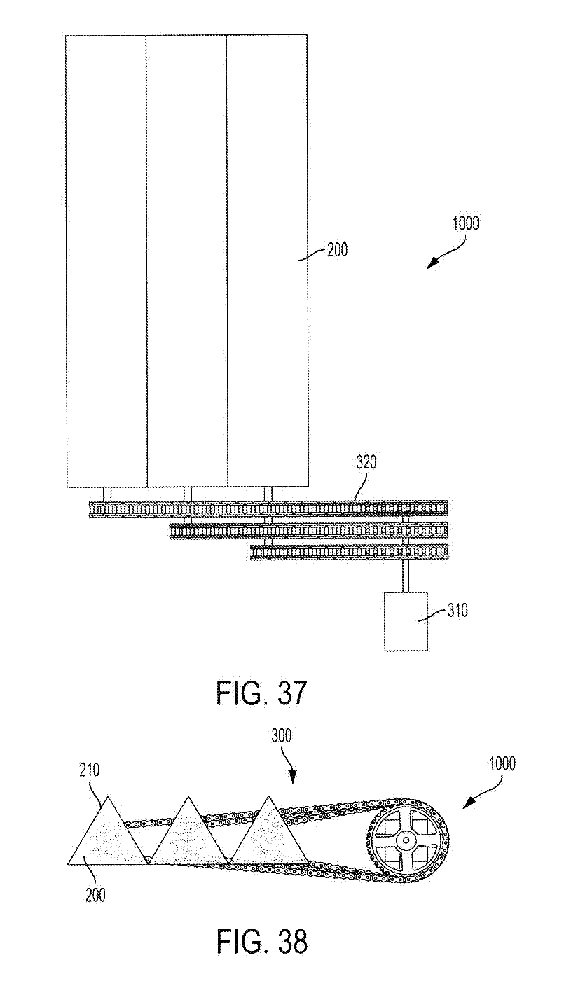

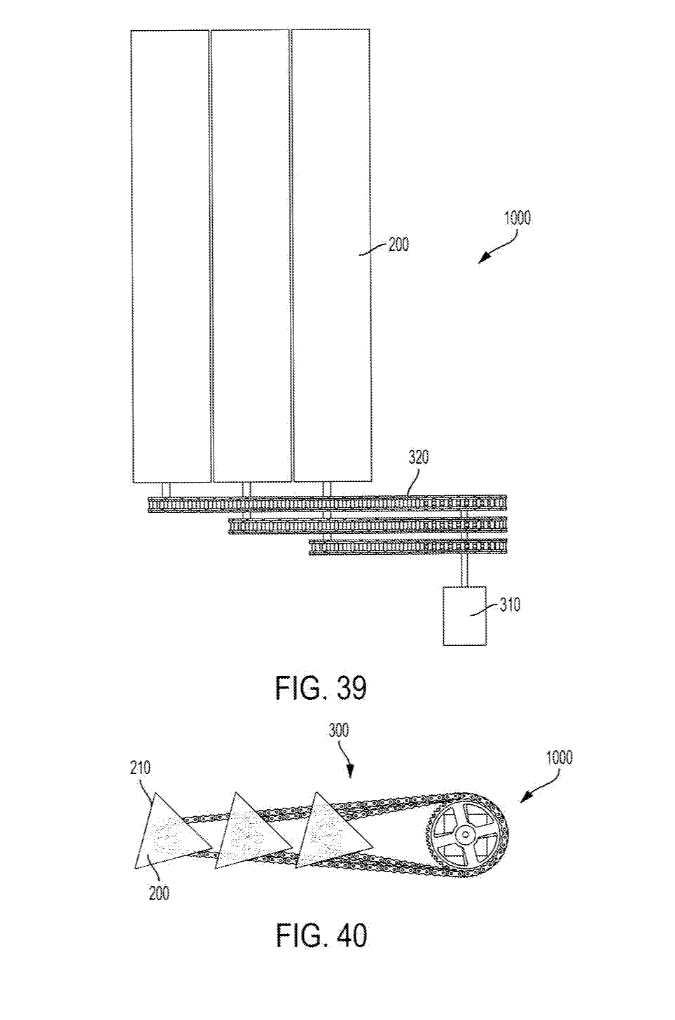

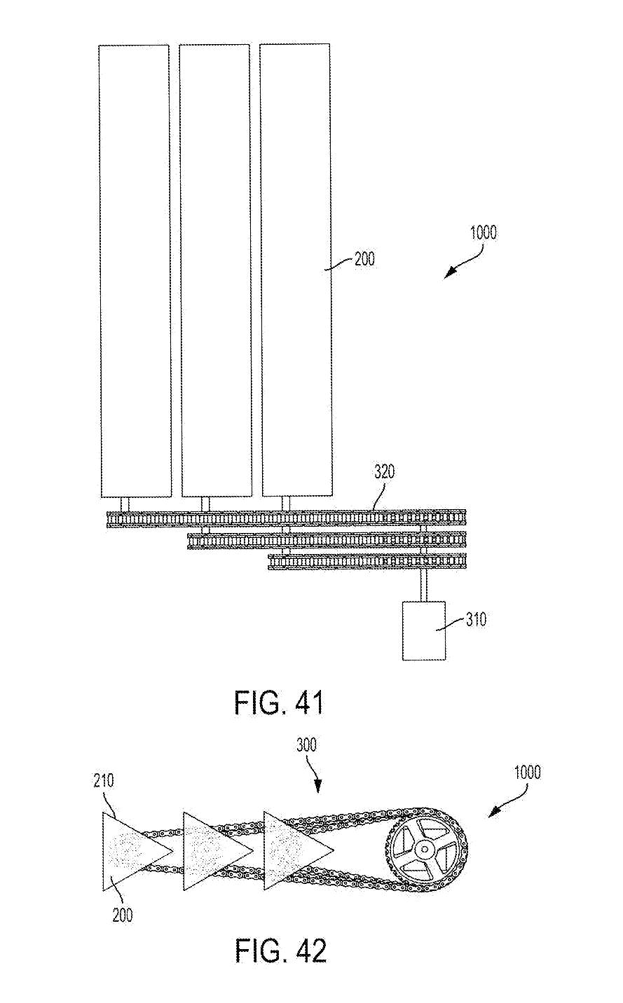

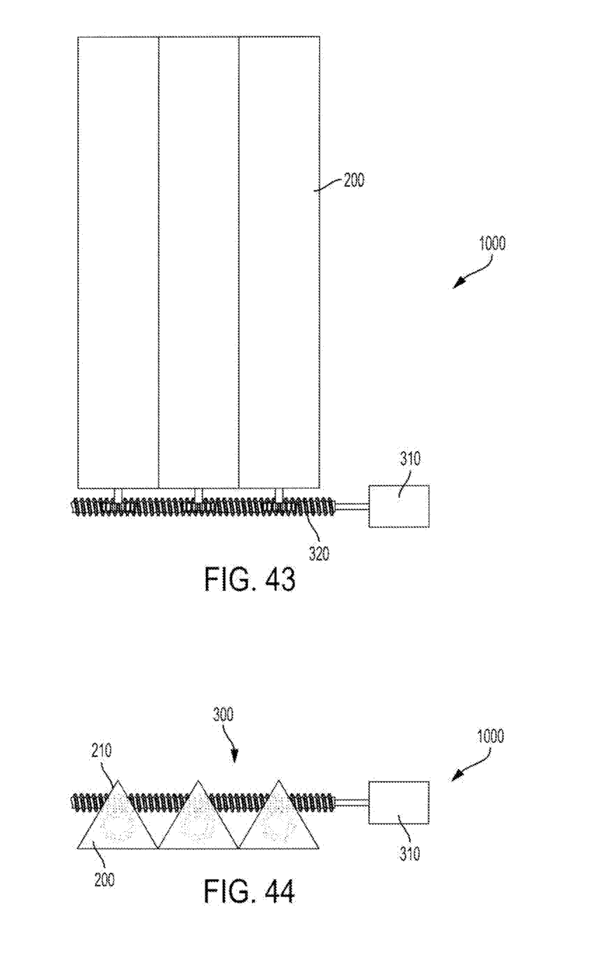

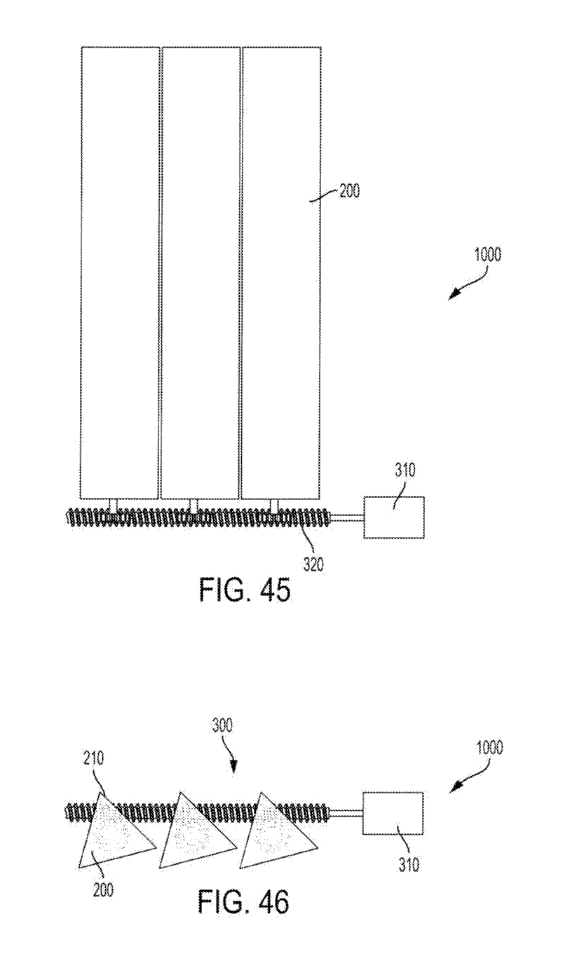

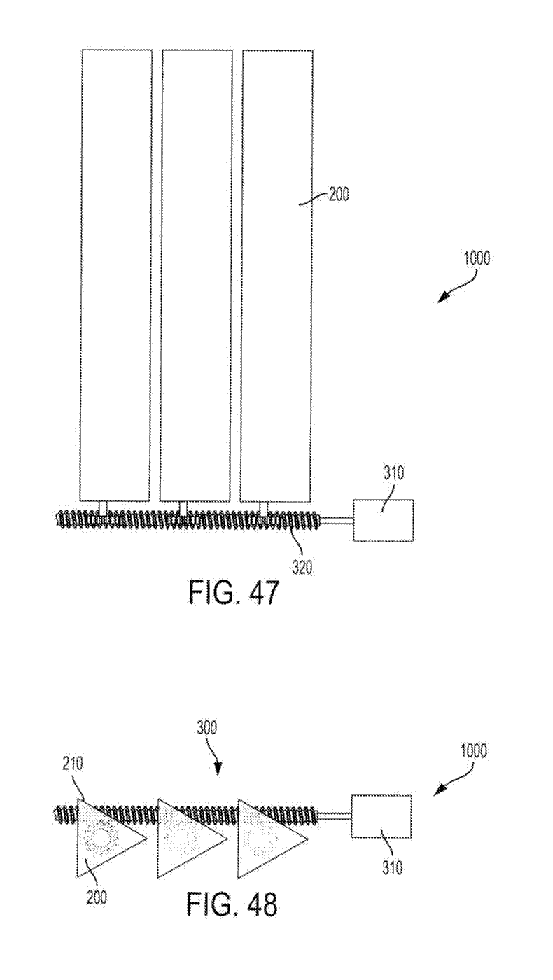

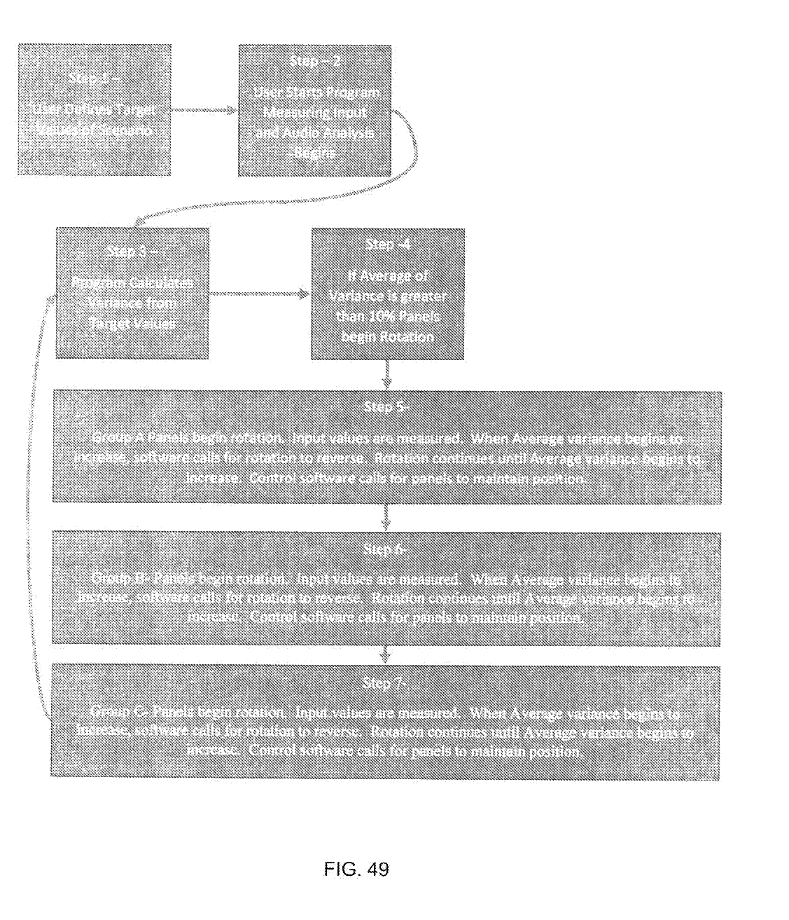

Referring again to FIG. 6, baffles 200 may be mounted on a rotating mount, spindle or axle within frame 100. The rotating mount, spindle or axle is operatively attached to a drive 300. Drive mechanism 300 comprises motor 310 and drive train 320. As shown generally in FIGS. 1-48, drive train 320 may comprise a variety of generally known configurations. For example, drive train 320 may comprise a rack and gear system, a belt and pulley system, a chain and sprocket system, or worm gears. The rack, drive shaft, worm gears, belts or chains will be turned or moved by an electric, pneumatic or hydraulic motor 310. However, it contemplated within the scope of the present invention that baffles 200 may also be translatably attached to frame 100 such that each baffle 200 or group of baffles 200 may move laterally or vertically relative to frame 100 in response to urged motion from drive apparatus 300.

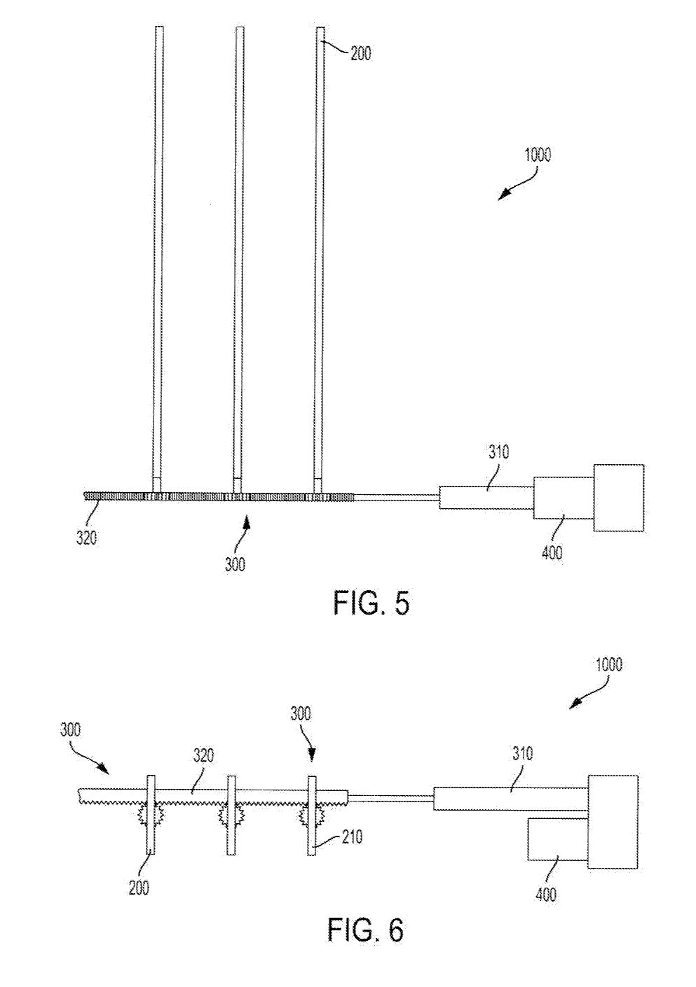

Referring still to FIG. 5, when motor 310 is engaged, drive train 320 rotates baffles 200 to the desired position to expose the surface of panel 210 that is most desirable for the acoustic optimization of the venue or space in which a panel 210 is installed.

Referring now again to FIG. 1, drive assembly 300 is functionally attached to an electronic control apparatus 400. Control apparatus 400 is adapted to regulate the flow of electricity, hydraulic fluid or compressed gas to motor 310 to affect the motion of drive train 320 and baffles 200. There may be a unique control apparatus 400 for each baffle 200 within a venue or space so that each baffle 200 can be able to be adjusted independently to optimize the acoustical performance of the physical space. Alternatively, a plurality of baffles 200 may be adjusted as a unit.

Control apparatus 400 further comprises an electronic input device 410 such as a computer or other programmable CPU. Electronic CPU 410 comprises acoustical software adapted to move baffles 210 to a position predetermined by a user based on acquired acoustic measurement of the relevant space. Alternatively, the acoustical optimization software of electronic CPU 410 may be adapted to receive inputs from sensors including such as microphones, thermometers, motion detectors, etc. and programmed to achieve desired acoustic properties (outputs) based on information from said sensors.

The acoustical optimization software may control one or a network of mechanically adjustable baffles 200 or acoustical panels 210. The software may use pre-defined tolerances and limits along with user input to analyze the acoustical performance of a venue or performance space. The software may then utilize a network of microphones or other sensory input devices to measure the acoustical performance of a venue or performance space. The software may then compare the acoustical performance against pre-determined criteria set by the user. The software may then move acoustical panels 210 to optimize the acoustical performance of the space of venue using an algorithm that chooses which panel(s) to adjust and will adjust the panel until the optimal acoustical performance has been reached. The optimal acoustical performance can be measured using linear programming. Harnessing the computing power, statistical analysis and the infinite adjustments between the tolerances of the mechanically adjustable acoustical panels, the software will be capable of finding solutions that are not otherwise be apparent utilizing traditional sound engineering techniques.

In one illustrative embodiment of system 1000, a user of system 1000 first interacts with electronic cpu 410 using a known means, such a keyboard, microphone, touchscreen, “mouse,” or similar device to define a desired “sound profile” for an event or performance that is to take place and be recorded in a facility.

In the illustrative embodiment of a method of using system 1000, the software of system 1000 allows previously determined sound profiles to saved and reloaded by name. Examples may include: Speaker stage Center, Full Rock Concert, Acoustic Singer/Guitarist, Classical ensemble 4 pieces Stage Center, Classical ensemble 4 pieces room Center. Each sound profile can be customized by an end user after it has been loaded and saved anew.

The software may further be selectively adapted to adjust the location of baffles 200 in unison in conjuction with a “master” input device. By using system 1000, changes can be made to the physical structure of a recording space from one use (for example, a spoken word performance) to another (such as, a jazz ensemble).

In a second step, the illustrative embodiment of a method of using system 1000 further comprises using input devices to communicate data to electronic CPU 410 of control apparatus 400 of system 1000. Exemplary input devices include high fidelity microphones positioned throughout a given performance space. The input of these microphones will be channeled through the software. The input values will be utilized to determine current state of the room acoustics. The variance of input frequencies will be measured and totaled using a mathematical formula to bring the input to the same units of measure, where:

Calculated Variance=|[1−(Inputmode/Target Value)]|×Importance Factor

In an exemplary embodiment, if the sum of Calculated Variance divided by the number of Variables is less than a previously set number, such as 10%, or a user defined number, no adjustments to baffles 200 will be made. One function of the software is to minimize the sum of the calculated variance which is the absolute value of the % difference between the Inputmode and the Target Value for each variable measured, where:
The Inputmode is the most occurring value in a given data set;
The data set will be created by measuring and temporarily recording the values of a given variable; and
The interval of the recording to create the data set will be determined during software development and could be measured as often as several times per second to create a useful data set.

The software is adapted to normalize the Calculated Variance as a % of variance from target values. Once the % of variance from Target levels is established the formula will find the absolute value of this variance. The absolute value of the % of Variance from target will then be multiplied by an Importance factor. The importance factor will allow the end user to prioritize the variables. This “optimization formula” is not true linear programming because there are no true “constraint” formulas. The constraints are the infinite number of input results as influenced by each mechanically adjustable baffle as it rotates 360 degrees. Next, the control software will alter the physical orientation or location of baffles 200 to achieve the desired acoustic results using the process shown in FIG. 12, where:

In a first step, a user defines “Target Values” of a Scenario.”

In a second step, a user starts program measuring input and analyzing audio.

In this step, a user will input data to define the desired sound profile for the event or use of the facility as shown in the following exemplary Table 1:

TABLE 1

| | |
|---|---|
| Master Volume Target: | X dB |
| Reverberation: | Seconds |
| 0-20 Hz: | X dB |
| 20 Hz-25 Hz: | x dB |
| 25 Hz-31.5 Hz: | x dB |
| 31.5 Hz-40 Hz: | x dB |
| 40 Hz-50 Hz: | x dB |
| 50 Hz-63 Hz: | x dB |
| 63 Hz-80 Hz: | x dB |
| 80 Hz-100 Hz: | x dB |
| 100 Hz-125 Hz: | x dB |
| 125 Hz-160 Hz: | x dB |
| 160 Hz-200 Hz: | x dB |
| 200 Hz-250 Hz: | x dB |
| 250 Hz-315 Hz: | x dB |
| 315 Hz-400 Hz: | x dB |
| 400 Hz-500 Hz: | x dB |
| 500 Hz-630 Hz: | x dB |
| 630 Hz-800 Hz: | x dB |
| 1000 Hz-1,250 Hz: | x dB |
| 1,250 Hz-1600 Hz: | x dB |
| 1600 Hz-2000 Hz: | x dB |
| 2,000 Hz-2500 Hz: | x dB |
| 2500 Hz-3150 Hz: | x dB |
| 3150 Hz-4000 Hz: | x dB |
| 4000 Hz-5000 Hz: | x dB |
| 5000 Hz-6300 Hz: | x dB |
| 6300 Hz-8000 Hz: | x dB |
| 1000 Hz-1,250 Hz: | x dB |
| 10,000 Hz-12,500 Hz: | x dB |
| 16,000 Hz-20,000 Hz: | x dB |
| 20,000 Hz-40,000 Hz: | x dB |

Previously configured data sets can be saved as a “Scenario” and reloaded by the user. Examples of Scenarios include Speaker stage Center, Full Rock Concert, Acoustic Singer/Guitarist, Classical ensemble 4 pieces Stage Center, Classical ensemble 4 pieces room Center. These Scenarios will be nothing more than previous values that have been saved for future use. The Scenario can be customized by the end user after it has been loaded. The Scenario, after having been modified, can be saved as a new Scenario with a unique name.

The software may further comprise preset scenarios. These pre-set scenarios may be based upon the actual sound signatures of venues throughout the world. The sound signature of these famous venues will be recorded and translated into a set of scenario values that can then be utilized to allow any venue with electronically controlled acoustical baffles to obtain a similar acoustic signature as the venue from which the pre-set targets were obtained.

The sound signatures will be recorded using an array of input microphones placed at a pre-determined proportion to relative to the venues size. After the microphones are placed white noise encompassing all frequencies broadcast at the same volume will be played through a sound system. The signature or fingerprint of the facility will be recorded by the microphone array. These values of the recorded white noise will then be translated into a preset scenario.

Input microphones will then be placed within the facility equipped with the electronically controlled acoustical baffles. The input microphones will be placed at the same proportion as the recording microphones as it relates to the proportions of the performance space.

A combination of the control software and the mechanical baffles will allow the end user to accurately reproduce the acoustical signature of a famous venue by tuning the performance space.

In the preferred embodiment, the User Interface will be a series of tabs like a web browser. Multiple Scenarios can be open and ready for use. User can, change active scenario as needed to accommodate changes in program audio. For example, as a guest speaker ends a speech, the user may change a Scenario to accommodate a Full Rock Band as it starts playing. A button stating “Next Scenario” may be utilized.

For example, the present invention may comprise a method of modifying the acoustic characteristics of a recording space, said method comprising the steps of: providing a plurality of selectively movable acoustic panels; providing a motor, said motor operatively connected to said panels; providing a controller, said controller functionally connected to said motor; providing a plurality of sound profile data, said sound profile data matching the acoustic properties of a known physical space; providing a plurality of microphones in said recording space; inputting sound profile data from said microphones into a software program; using said program to compare the sound profile data for the recording space to the sound profile data of the known physical space; programing said controller to move at least one panel of said plurality of movable panels according to a predetermined algorithm to adapt said recording space to match the acoustic properties of said known physical space.

The present invention next, calculates Variance from Target Values. High Fidelity microphones may be positioned throughout a given performance space. The input of these microphones will be channeled through the control software. The input values will be utilized to determine current state of the room acoustics. The variance of input frequencies will be measured and totaled using the following mathematical formula to bring the input to the same units of measure:

Calculated Variance=≡[1−(Inputmode/Target Value)]|×Importance Factor

TABLE 2

| | |
|---|---|
| Master Volume | Calculated Variance |
| Target: Reverberation: | Calculated Variance |
| 0-20 Hz: | Calculated Variance |
| 20 Hz-25 Hz: | Calculated Variance |
| 25 Hz-31.5 Hz: | Calculated Variance |
| 31.5 Hz-40 Hz: | Calculated Variance |
| 40 Hz-50 Hz: | Calculated Variance |
| 50 Hz-63 Hz: | Calculated Variance |
| 63 Hz-80 Hz: | Calculated Variance |
| 80 Hz-100 Hz: | Calculated Variance |
| 100 Hz-125 Hz: | Calculated Variance |
| 125 Hz-160 Hz: | Calculated Variance |
| 160 Hz-200 Hz: | Calculated Variance |
| 200 Hz-250 Hz: | Calculated Variance |
| 250 Hz-315 Hz: | Calculated Variance |
| 315 Hz-400 Hz: | Calculated Variance |
| 400 Hz-500 Hz: | Calculated Variance |
| 500 Hz-630 Hz: | Calculated Variance |
| 630 Hz-800 Hz: | Calculated Variance |
| 1000 Hz-1,250 Hz: | Calculated Variance |
| 1,250 Hz-1600 Hz: | Calculated Variance |
| 1600 Hz-2000 Hz: | Calculated Variance |
| 2000 Hz-2500 Hz: | Calculated Variance |
| 2500 Hz-3150 Hz: | Calculated Variance |
| 3150 Hz-4000 Hz: | Calculated Variance |
| 4000 Hz-5000 Hz: | Calculated Variance |
| 5000 Hz-6300 Hz: | Calculated Variance |
| 6300 Hz-8000 Hz: | Calculated Variance |
| 1000 Hz-1,250 Hz: | Calculated Variance |
| 10,000 Hz-12,500 Hz: | Calculated Variance |
| 16,000 Hz-20,000 Hz: | Calculated Variance |
| 20,000 Hz-40,000 Hz: | Calculated Variance |

SUM OF CALCULATED VARIANCE

In the exemplary embodiment, if the sum of calculated variance divided by the number of Variables is less than 10%, no adjustments to baffles will be made. The interval of the recording to create a data set will be determined during software development and could be measured as often as several times per second to create a useful data set.

The Calculated Variance will be a normalized value representing the % of variance from target values. Once the % of variance from Target levels is established the formula will find the absolute value of this variance. The absolute value of the % of Variance from target will then be multiplied by an Importance factor. The importance factor will allow the end user to prioritize the variables. This “optimization formula” is not true linear programming because there are no true “constraint” formulas. The constraints are the infinite number of input results as influenced by each mechanically adjustable baffle as it rotates 360 degrees. Control Software will call for Adjustment of Mechanically Adjustable Acoustical Panels. Panels/Baffles within a recording space may operate in predetermined groups, i.e. “A,” “B,” and “C.”

Next, if Average of Variance is greater than 10% Panels begin Rotation.

Once Group A Panels begin rotation. Input values are measured. When Average variance begins to increase, software calls for rotation to reverse. Rotation continues until Average variance begins to increase. Control software calls for panels to maintain position.

Next, once Group B—Panels begin rotation. Input values are measured. When Average variance begins to increase, software calls for rotation to reverse. Rotation continues until Average variance begins to increase. Control software calls for panels to maintain position.

Next, once Group C—Panels begin rotation. Input values are measured. When Average variance begins to increase, software calls for rotation to reverse. Rotation continues until Average variance begins to increase. Control software calls for panels to maintain position.

The software and its related feedback from input microphones will also be capable of finding optimal performance given variables that otherwise may be immeasurable such as crowd size, crowd positioning and composition of all elements and people within a given venue or performance space.

The software may utilize real time feedback from a network of microphones to measure acoustical performance. The software may determine whether the real time feedback is near the optimal ranges determined by the user. If the input levels are not optimal, the software will adjust acoustical panels 210 to so optimize. The acoustical inputs can then be re-measured to determine whether the result of the adjustments has brought the inputs closer to an optimal result. Real time feedback will be analyzed and linear programming determine when the variance from optimal has been minimized.

The real time analysis of data and the real time adjustment of panels 210 will provide sound engineers and sound technicians with the ability to optimize the acoustical performance of a room. These adjustments made with the real time input from microphones can call for acoustical adjustments based upon crowd size, crowd composition, positioning of stage implements, position of props and any other object that may enter a room, move about the room or otherwise change the sound profile of a venue or performance space.

As the software seeks optimal performance by adjusting panels 210 and measuring results, it will provide the sound technicians to find combinations of acoustical reflective, acoustical diffusion and acoustical absorption that may not be readily apparent or previously possible given today's technical environment and sound engineering tools and equipment. This nearly infinite adjustment will also allow for optimal acoustical performance within venues or spaces that may be temporary or poorly designed as it relates to acoustical performance.

The nature of the optimization software and the real time feedback will allow users to handle several contingencies. If one of the many panels 210 fails, other panels 210 will continue to adjust so as to bring the room as close to optimal as possible. This same scenario may involve failing sound equipment, microphones or other acoustical equipment.

Control apparatus 400 may be functionally connected to each panel 210 using cables, Wi-Fi, Bluetooth and other forms of wireless or wired communication. Control apparatus 400 will allow panels 210 to be adjusted from maximum sound reflectance to maximum sound absorption and an infinite number of variances in between. This adjustability and computerized control will provide the maximum amount of adjustability and performance options for the user acoustical engineer and sound technicians to physically change and optimize the physical characteristics of the venue or performance space.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An acoustic modulation system for a physical space, said system comprising: at least one acoustic panel, each of said at least one acoustic panel movably attached to a frame; a motor for moving said at least one panel relative to said frame, said motor mechanically connected to each of said at least one panels; a programmable controller, said controller operatively connected to said motor, said controller adapted to selectively engage said motor to move at least one panel of said at least one panel.

2. The system of claim 1, further comprising a plurality of sensors, said sensors selected from the group consisting of microphones, position sensors, thermometers, and pressure sensors.

3. The system of claim 1, wherein each panel of said at least one panel is independently movable.

4. The system of claim 1, wherein each of said panels is capable of movement selected from the group consisting of lateral translation, vertical translation, and rotation.

5. The system of claim 1, wherein each of said panels comprises a unique material on each side.

6. An acoustic modulation system for a physical space, said system comprising: a plurality of baffles, each baffle comprising at least two acoustic panels disposed on sides of said baffle, each said baffle movably attached to a frame; a motor for moving at least one of said plurality of baffles relative to said frame, said motor mechanically connected to each of said plurality of baffles; a programmable controller, said controller operatively connected to said motor, said controller adapted to selectively engage said motor to move at least one of said baffles.

7. The system of claim 6, further comprising a plurality of sensors, said sensors selected from the group consisting of microphones, position sensors, thermometers, and pressure sensors.

8. The system of claim 6, wherein each of said plurality of baffles is independently movable.

9. The system of claim 6, wherein each baffle of said plurality of baffles is capable of movement selected from the group consisting of lateral translation, vertical translation, and rotation.

10. The system of claim 6, wherein each of said panels comprises a unique material on each side.

11. A method of modifying the acoustic characteristics of a predetermined physical space, said method comprising the steps of: providing a plurality of selectively movable acoustic panels; providing a motor, said motor operatively connected to said panels; providing a controller, said controller functionally connected to said motor; providing a plurality of sensors, said sensors selected from the group consisting of microphones, position sensors, thermometers, and pressure sensors, said sensors communicatively connected to said controller; programing said controller to move at least one panel of said plurality of movable panels according to a predetermined algorithm and data inputted to said controller from said sensors.

12. A method of modifying the acoustic characteristics of a recording space, said method comprising the steps of: providing a plurality of selectively movable acoustic panels; providing a motor, said motor operatively connected to said panels; providing a controller, said controller functionally connected to said motor; providing a plurality of sound profile data, said sound profile data matching the acoustic properties of a known physical space; providing a plurality of microphones in said recording space; inputting sound profile data from said microphones into a software program; using said program to compare the sound profile data for the recording space to the sound profile data of the known physical space; programing said controller to move at least one panel of said plurality of movable panels according to a predetermined algorithm to adapt said recording space to match the acoustic properties of said known physical space.

13. An acoustic modulation system for a physical space, said system comprising: at least one acoustic panel, each of said at least one acoustic panel movably attached to a frame; a mechanical crank for moving said at least one panel relative to said frame, said crank mechanically connected to each of said at least one panels.

14. The system of claim 13, wherein each panel of said at least one panel is independently movable.

15. The system of claim 13, wherein each of said panels is capable of movement selected from the group consisting of lateral translation, vertical translation, and rotation.

16. The system of claim 13, wherein each of said panels comprises a unique material on each side.

17. An acoustic modulation system for a physical space, said system comprising: a plurality of baffles, each baffle comprising at least two acoustic panels disposed on sides of said baffle, each said baffle movably attached to a frame; a crank for moving at least one of said plurality of baffles relative to said frame, said crank mechanically connected to each of said plurality of baffles.

18. The system of claim 17, further comprising a plurality of sensors, said sensors selected from the group consisting of microphones, position sensors, thermometers, and pressure sensors.

19. The system of claim 17, wherein each of said plurality of baffles is independently movable.

20. The system of claim 17, wherein each baffle of said plurality of baffles is capable of movement selected from the group consisting of lateral translation, vertical translation, and rotation.

21. The system of claim 17, wherein each of said panels comprises a unique material on each side.
